(19) United States
(12) Patent Application Publication
(10) Pub. No.: US 2021/0045381 A1
(43) Pub. Date: Feb. 18, 2021

(54) FORMULATIONS

(71) Applicant: SYNGENTA PARTICIPATIONS AG, Basel (CH)

(72) Inventors: Gordon Alastair BELL, Bracknell, Berkshire (GB); Christopher Ian LINDSAY, Bracknell, Berkshire (GB); Faheem Noorahmed PADIA, Bracknell, Berkshire (GB)

(73) Assignee: SYNGENTA PARTICIPATIONS AG, Basel (CH)

(21) Appl. No.: 16/976,303

(22) PCT Filed: Feb. 26, 2019
(86) PCT No.: PCT/EP2019/054731

§ 371 Date: Aug. 27, 2020

(30) Foreign Application Priority Data
Feb. 27, 2018 (GB) 1803201.1

(51) Int. Cl. A01N 25/34; B33Y 70/00; B33Y 80/00

(52) U.S. Cl. CPC A01N 25/34; A01N 41/06; B33Y 80/00; B33Y 70/00

(57) ABSTRACT

This invention relates to a solid object prepared using three dimensional printing. The object contains one or more agrochemicals and also a surfactant or an oil; and, for example, may be in the form of a pill, capsule or granule, and may be of lozenge profile. A solid object manufactured by three dimensional printing is a convenient way to dose and apply an agrochemical to, for example, foliage, soil or a pest.

This invention relates to a solid object prepared using three dimensional printing. The object contains one or more agrochemicals and also a surfactant or an oil; and, for example, may be in the form of a pill, capsule or granule, and may be of lozenge profile. A solid object prepared by three dimensional printing is a convenient way to dose and apply (directly or indirectly) an agrochemical to, for example, foliage, soil or a pest.

Release of an agrochemical from a solid object prepared by three dimensional printing may be initiated by factors such as water, soil moisture, temperature, pH and the environment of use. The release of agrochemical may be controlled by selection of suitable materials of construction and/or the structure of the solid object.

These solid objects may be applied to soil; either broadcast on the surface or else placed using machinery such as an agrochemical drill at a depth chosen by the applicator. The positioning of the solid objects may be used to control the efficacy of the formulation.

The use of three dimensional printing to form pharmaceutical containing polypills is known and has been described by Kaled (Kaled S. A., Burley J. C., Alexander M. R., Yang J. and Roberts C. J. Journal of controlled release, 217(2015) 308-314). In this paper the concept of a multicomponent pill is described as is the release of the pharmaceuticals. Pharmaceuticals however are very different from agrochemicals. While they are both used to deliver a biological effect, they have to be formulated differently and they are applied in very different manners. Interference by individual formulation components may be a major consideration as might effects such as evaporation of low vapour pressure liquids. We herein disclose the use of formulations specific to the agrochemical industry and show that it is possible to manufacture solid objects containing agrochemicals. In addition to this we describe ways that these solid objects can be applied to soil or to a spray tank which are unique compared to pharmaceutical applications.

The present invention relates to a solid object manufactured by three dimensional printing and which comprises an agrochemical and a surfactant or an oil (preferably a surfactant).

The three dimensional printing may be achieved via an extrusion or a spraying process. Heating or cooling may be used to control the viscosity of the material being printed three dimensionally.

Suitably the surfactant is a non-ionic surfactant; more suitably the surfactant is an alkyl ethoxylate or a polyoxyethylene sorbitan alkyl or akenyl ester.

A surfactant or an oil may help to effectively dissolve or disperse an agrochemical and hence control its release profile from a 3-D solid object; it may also effect subsequent translocation of an agrochemical in soil.

Suitably the solid object further comprises a solvent,

A suitable method for manufacture of the solid objects of the present invention is described in WO2016/172699 (for example, commencing on page 1). Suitable methods for preparing a solid object according to the present invention include extrusion and spraying (for example ink-jet printing) using three dimensional printing

In the solid objects of the present invention, the agrochemical may be wholly or partially distributed on the surface of the solid object or may be wholly or partially encapsulated within the solid object. The solid object may comprise a polmer or a wax, suitably at a concentration by weight of from 5% to 95%. Encapsulation makes possible a defined release profile (for example, instantaneous, delayed, continuous, step-wise or triggered release) of an agrochemical during its subsequent use. If more than one agrochemical is present, the release profile of each agrochemical may be the same as or independent of any other agrochemical that is present.

Whilst the object of the present invention is referred to here as a solid object, it may of course comprise a liquid component (for example, a liquid absorbed on to a filler or carrier; or a liquid contained within (micro-)capsules where the (micro-)capsules have been incorporated into the solid object by means of three dimensional printing. Such a liquid may be the agrochemical itself or another formulation component (such as a surfactant). Of course, an agrochemical (or indeed any other component) may also be used in the three dimensional printing as a solution (in an aqueous or non-aqueous solution) or a fine suspension (in an aqueous or non-aqueous medium) or as a fine powder or dust.

Additional components, such as surfactants, emulsifiers and solvents, are well known to the man skilled in the art: standard formulation publications disclose such formulation components suitable for use with the present invention (for example, Chemistry and Technology of Agrochemical Formulations, Ed. Alan Knowles, published by Kluwer Academic Publishers, The Netherlands in 1998; and Adjuvants and Additives: 2006 Edition by Alan Knowles, Agrow Report DS256, published by Informa UK Ltd, December 2006). Further standard formulation components suitable for use with the present invention are disclosed in WO2009/130281A1 (see from page 46, line 5 to page 51, line 40). Examples of suitable anionic, non-ionic and cationic surfactants are listed, for example, in U.S. Pat. No. 6,063,732 column 5, line 1 to column 6, line 2. Furthermore, the surfactants customarily employed in formulation technology, which are described, inter alia, in “Mc Cutcheon's Detergents and Emulsifiers Annual” MC Publishing Corp., Ridgewood N.J., 1981, Stache, H., “Tensid-Taschenbuch”, Carl Hanser Verlag, Munich Vienna, 1981 and M. and J. Ash, “Encyclopedia of Surfactants”, Vol I-III, Chemical Publishing Co., New York, 1980-81, are also suitable for preparation of the compositions.

The noun “agrochemical” and term “agrochemically active ingredient” are used herein interchangeably, and include herbicides, insecticides, nematicides, molluscicides, fungicides, plant growth regulators and safeners; preferably herbicides, insecticides and fungicides.

An agrochemical, or a salt of an agrochemical, selected from those given below, may be suitable for the present invention.

Suitable herbicides include pinoxaden, bicyclopyrone, mesotrione, fomesafen, tralkoxydim, napropamide, amitraz, propanil, pyrimethanil, dicloran, tecnazene, toclofos methyl, flamprop M, 2,4-D, MCPA, mecoprop, clodinafop-propargyl, cyhalo fop-butyl, diclofop methyl, haloxyfop, quizalofop-P, indol-3-ylacetic acid, 1-naphthylacetic acid, isoxaben, tebutam, chlorthal dimethyl, benomyl, benfuresate, dicamba, dichlobenil, benazolin, triazoxide, fluazuron, teflubenzuron, phenmedipham, acetochlor, alachlor, metolachlor, pretilachlor, thenylchlor, alloxydim, butroxydim, clethodim, cyclodim, sethoxydim, tepraloxydim, pendimethalin, dinoterb, bifenox, oxyfluorfen, acifluorfen, fluazifop, S-metolachlor, glyphosate, glufosinate, paraquat, diquat, fluoroglyco fen-ethyl, bromoxynil, ioxynil, imazamethabenz-methyl, imazapyr, imazaquin, imazethapyr, imazapic, imazamox, flumioxazin, flumiclorac-pentyl, picloram, amodosulfuron, chlorsulfuron, nicosulfuron, rimsulfuron, triasulfuron, triallate, pebulate, prosulfocarb, molinate, atrazine, simazine, cyanazine, ametryn, prometryn, terbuthylazine, terbutryn, sulcotrione, isoproturon, linuron, fenuron, chlorotoluron, metoxuron, iodosulfuron, mesosulfuron, diflufenican, flufenacet, fluroxypyr, aminopyralid, pyroxsulam, XDE-848 Rinskor and halauxifen-methyl.

Suitable fungicides include isopyrazam, mandipropamid, azoxystrobin, trifloxystrobin, kresoxim methyl, mefenoxam, famoxadone, metominostrobin and picoxystrobin, cyprodanil, carbendazim, thiabendazole, dimethomorph, vinclozolin, iprodione, dithiocarbamate, imazalil, prochloraz, fluquinconazole, epoxiconazole, flutriafol, azaconazole, bitertanol, bromuconazole, cyproconazole, difenoconazole, hexaconazole, paclobutrazole, propiconazole, tebuconazole, triadimefon, trtiticonazole, fenpropimorph, tridemorph, fenpropidin, mancozeb, metiram, chlorothalonil, thiram, ziram, captafol, captan, folpet, fluazinam, flutolanil, carboxin, metalaxyl, bupirimate, ethirimol, dimoxystrobin, fluoxastrobin, orysastrobin, metominostrobin, prothioconazole, adepidyn, bixafen, fludioxinil, fluxapyroxad, prothioconazole, pyraclostrobin, revysol, solatenol and xemium.

Suitable insecticides include thiamethoxam, imidacloprid, acetamiprid, clothianidin, dinotefuran, nitenpyram, fiprinil, abamectin, emamectin, tefluthrin, emamectin benzoate, bendiocarb, carbaryl, fenoxycarb, isoprocarb, pirimicarb, propoxur, xylylcarb, asulam, chlorpropham, endosulfan, heptachlor, tebufenozide, bensultap, diethofencarb, pirimiphos methyl, aldicarb, methomyl, cyprmethrin, bioallethrin, deltamethrin, lambda cyhalothrin, cyhalothrin, cyfluthrin, fenvalerate, imiprothrin, permethrin, halfenprox, chlorantraniliprole, oxamyl, flupyradifurone, sedaxane, inscalis, rynaxypyr, sulfoxaflor and spinetoram.

Suitable plant growth regulators include paclobutrazole, trinexapac-ethyl and 1-methylcyclopropene.

Suitable safeners include benoxacor, cloquintocet-mexyl, cyometrinil, dichlormid, fenchlorazole-ethyl, fenclorim, flurazole, fluxofenim, mefenpyr-diethyl, MG-191, naphthalic anhydride and oxabetrinil.

The various editions of The Pesticide Manual [especially the 14th and 15th editions] also disclose details of agrochemicals, any one of which may suitably be used in the present invention.

Suitably, the agrochemical is azoxystrobin or fomesafen.

A solid object manufactured by three dimensional printing may be used as a bait against pests (for example, to provide a rat bait).

Suitably, the concentration of the agrochemical in the solid object, is from 0.1% to 75% of the total weight of the object (preferably from 5 and 50%; and most preferably from 10% to 25% of the total weight).

The solid object may comprise more than one agrochemical (for example, in a bi-layer solid object where there are two sections, each comprising different (or even the same) agrochemicals but with different release rate profiles; an effect achieveable via the inclusion of a surfactant (or oil) within the solid object.

The solid object of the present invention may include other ingredients such as an anti-foam agent, an anti-bacterial agent, a colourant, a perfume, an emetic, a flavour or a stench.

The solid object may also comprise a salt, to aid dissolution or break up the solid object when added to an aqueous environment (such as a farmer's spray tank or soil).

Suitably, the concentration of the surfactant or oil (or the combination of any such ingredients) in the solid object, is from 1% to 99% of the total weight of the solid object (preferably from 5 and 75%; and most preferably from 10% to 25% of the total weight).

The presence of a surfactant or oil in the solid object can be used to have influence of the release profile of an active ingredient from the solid object.

A solid object may be applied to the soil in a manner similar to the application of seeds. This may involve direct drilling or a similar process whereby the solid object is placed in the soil. The placement may include a seed or may be near to a seed so that the solid object provides protection to the seed (i.e. the solid object may comprise a seed). Application of a solid object comprising a seed and a herbicide is also possible although this is unlikely to include drilling in seed beds or where the herbicide will be near to a seed. Several different solid objects of the present invention can be applied at the same time. The decision as to which seeds are applied together or alone can be made prior to application or else according to data collected at the time of drilling.

In another aspect of the present invention, the solid object manufactured using three dimensional printing may be a seed that has been coated by polymer and which comprises an agrochemical.

One advantage of the solid objects of the present invention is that they may offer non-dusty alternatives to conventional agrochemical products such as WPs (Wettable Powders).

Alternative advantages of the solid objects of the present invention include the ability to control the release of an active ingredient (a.i.) from the solid object. In fact by, for example, sequential layering of polymer(s) (to build up different sections within the solid object) and active ingredient(s) it may be possible to provide objects with tailored release profiles, such as a rapid release of an active ingredient optionally followed by a sustained release of that same a.i. or of another a.i.; or a triggered release (for example triggered by moisture, temperature or pH changes); or a time-delayed release. Furthermore, where two or more a.i.s may be either chemically or biologically incompatible with one another, polymer layering may be used to either separate the a.i.s from each other or to ensure that they are not released simultaneously to the surrounding environment. Likewise other formulation components (for example biological performance-enhancing adjuvants) may be kept separate from an a.i. within the object if there are physico-chemical reasons for so doing.

By preparing solid objects with different sections it is possible, for example, to provide one section in which has an agrochemical plus a surfactant or oil from which release of the agrochemical is faster (or slower) than that of an agrochemical (either the same agrochemical or a different one) from a separate section which may contain either no a surfactant or oil; or contains a different a surfactant or oil.

Accordingly, the present invention provides a solid object as described herein comprising two agrochemicals each in separate sections of the solid object.

The present invention also provides a solid object as described herein comprising two sections where release of an agrochemical from each section occurs under different release profiles.

Solid objects of the present invention may be added to a spray tank for dilution or dispersion in an aqueous system followed by subsequent spraying against a pest or locus of a pest.

Therefore in a further aspect, the solid object is added to an agricultural spray tank.

In another aspect the solid object is applied to soil; suitably by direct drilling into the soil, either alone or with a seed.

In a still further aspect the solid object is applied as part of a precision agriculture process whereby the solid object is applied supported by satellite and/or geographic information, to ensure the concentration of the agrochemical is controlled across a field.

More than one type of solid object, according to the present invention, may be mixed or blended together (and may have their size and/or density matched to prevent separation or segregation of different solid objects if stored together for long periods of time). Such blending or mixing may overcome incompatibility issues or may reduce manufacturing complexity and cost.

The present invention is illustrated by the following non-limiting examples.

### EXAMPLE 1

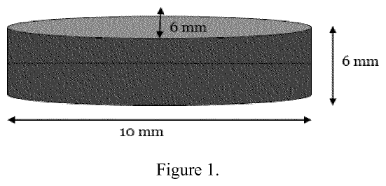

This Example illustrates the preparation of solid objects according to the present invention. Six solid objects (T1, T2 and T3 dry to T6 dry) were prepared using the ingredients shown in Table 1 (using the recipes T1 to T6). In each case the ingredients were mixed together and turned into a paste which was then extruded in a 3-D printer; the extrusion process was used to build up sequentially layers which formed solid objects having an oval cross-section profile (like a lozenge), with the dimensions 10 mm×6 mm×(6 mm depth); see FIG. 1.

After drying (i.e. removal of water) the solid objects were solid, dust free and easy to handle.

TABLE 1
Six solid object formulations - presented as
both weights used and as dry formulations.

| | T 1 | T 2 | T 3 | T 3 dry | T 4 |
|---|---|---|---|---|---|
| Ingredient | (% w/w) | (% w/w) | (mg) | (% w/w) | (mg) |
| Fomesafen | 60 | | 200 | 20 | |
| Azoxystrobin | | 60 | | | 200 |
| Starch | 40 | 40 | | | 325 |
| Lactose | | | 575 | 57.5 | 375 |
| Mannitol | | | | | |
| PVP | | | 125 | 12.5 | 100 |
| CCS | | | 100 | 10 | |
| Agnique ®FOH | | | | | |
| 9OC-20 | | | | | |
| Water | | | 1200 | | 1200 |

| | T 4 dry | T 5 | T 5 dry | T 6 | T 6 dry |
|---|---|---|---|---|---|
| Ingredient | (% w/w) | (mg) | (% w/w) | (mg) | (% w/w) |
| Fomesafen | | 200 | 20 | | |
| Azoxystrobin | 20 | | | 200 | 20 |
| Starch | 32.5 | | | 325 | 32.5 |
| Lactose | 37.5 | | | | |
| Mannitol | | 400 | 40 | 325 | 32.5 |
| PVP K25 | | 250 | 25 | 100 | 10 |
| CCS | | 100 | 10 | | |
| Agnique ®FOH | 10 | 50 | 5 | 50 | 5 |
| 9OC-20 | | | | | |
| Water | | 500 | | 400 | |

CCS is sodium croscarmelose which is a filler.
PVP K25 is polyvinylpyrrolidone homopolymer with a quoted Molecular Weight (weight average) of 24,000 Dalton.
Agnique ®FOH 9OC-20 is a commercially available alkyl ethoxylate surfactant sold by BASF.

### EXAMPLE 2

This Example illustrates the preparation of binary (two-sectioned) extruded solid objects. The recipes shown above for T3 and T4 were used to generate a single three dimensionally extrusion-printed binary solid object, T7, with the oval profile, the binary system being created by layering (as in Example 1 above) a thin section using one paste and then layering on top of that section a second section from a different extruded paste. Both sections in the solid object had the dimensions 10 mm×6 mm×3mm, with the lower section being of recipe T3 and the upper section being of recipe T4; giving a final solid object of 10 mm×6 mm×6 mm. This meant that the lower section contained the herbicide fomesafen whilst the upper section contained the fungicide azoxystrobin.
A similar binary solid object, T8, was also extruded using the recipes for T5 and T6, such that once again one section contained the herbicide fomesafen whilst the other section contained the fungicide azoxystrobin.
Comparing the recipes for T7 and T8, it will be seen that T7 (comprising T3 and T4) contains no surfactant) but in T8 both sections (T5 and T6) contain an alkyl ethoxylate surfactant, Agnique®FOH 90C-20.

### EXAMPLE 3

This Example illustrates a binary (two-sectioned) extruded solid object displaying both slow and fast release.
The release of pesticide from the 3-D printed binary solid object T7 of Example 2 (containing T3 and T4) was measured. In each experiment three T7 solid objects were added to a dissolution basket which was stirred at 30 rpm. Release was measured into water; into water containing a commercially available surfactant (S1); and into water with two different types of commercially available surfactant (S2). The results are shown in Table 2. The release of the herbicide fomesafen displays fast release. Binary solid object T7 released 64% of the pesticide in 720 minutes. The release of the fungicide azoxystrobin in the same time period was only 27%; this was slow release. Release rates into the two surfactant containing media were faster for both pesticides. S1 contained water with 0.5% w/w of Agnique®FOH 90C-20 whereas S2 contained water with 0.5% w/w Agnique®FOH 90C-20 and 1% Tween® 80.
Tween® 80 is a non-ionic surfactant: polyoxyethylene (20) sorbitan monooleate.

TABLE 2
Percentage Release from a binary solid object
T7 - containing fomesafen and azoxystrobin.

| | Water - | Water - | S1 - | S2 - |
|---|---|---|---|---|
| | after | after | after | after |
| Pesticide | 30 min. | 720 min. | 30 min. | 30 min. |
| Fomesafen | 23.6 | 64 | 39.3 | 45.9 |
| Azoxystrobin | 15.6 | 27 | 28.9 | 48.3 |

### EXAMPLE 4

This Example illustrates the effect of a surfactant of the release profile of a binary (two-sectioned) extruded solid object.
Similarly to Example 3, the releases of pesticides from the 3-D printed binary solid object T8 of Example 2 (containing T5 and T6) were measured; three solid objects T8 were added to a dissolution basket which was stirred at 30 rpm. Release was measured into water and the results are shown in Table 3. The release of the herbicide fomesafen displays fast release. Solid object T8 released 78% of this pesticide in 30 minutes showing (by comparison with the first column of Table 2) that the release rate had been increased by about a factor of three compared to the release rate from T7 (i.e. a similar formulation which does not contain surfactant). Furthermore, compared to solid object T7 releasing fomesafen into water which already contains a high concentration of the same surfactant (S1 of Example 2), the release from T8 (the formulation with built-in surfactant) was considerably faster (78% versus 39.3% [S1]).
The release of the fungicide azoxystrobin from T8 in the same time period was also dramatically faster than the T7 formulation which did not contain a surfactant (37% versus 15.6%). Similar to the case for fomesafen we also see that the T8 azoxystrobin section (with built-in surfactant) released considerably more of the azoxystrobin than the T7 (surfactant free) solid object releasing into a surfactant solution (37% versus 28.9%).

TABLE 3
Percentage Release from a binary solid object
T8 - containing fomesafen and azoxystrobin.

| | | Water - |
|---|---|---|
| Pesticide | Formulation | after 30 min |
| Fomesafen | T5 | 78 |
| Azoxystrobin | T6 | 37 |

These results demonstrate that pesticide release from a solid object with surfactant in the formulation is unexpectedly faster than a solid object without a surfactant. This is also the surprising case even where the medium in which the dissolution is carried out has a very high concentration of dissolved surfactant.

1-9. (canceled)

10. A solid object comprising a polymer prepared using three dimensional printing which also comprises a surfactant or an oil, and which further comprises two agrochemicals each in separate sections of the solid object.

11. The solid object of claim 10, in which release of an agrochemical from each section occurs under different release profiles.

12. A method, comprising: adding the solid object of claim 10 to an agricultural spray tank.

13. The method of claim 12, further comprising applying the solid object to soil.

14. The method of claim 13, the solid object is applied by direct drilling into the soil, either alone or with a seed.

15. The method of claim 12, further comprising applying the solid object to soil as part of a precision agriculture process whereby the applying is supported by satellite and/or geographic information, to ensure the concentration of the agrochemical is controlled across a field.
